(19) United States
(12) Patent Application Publication
(10) Pub. No.: US 2013/0132813 A1
(43) Pub. Date: May 23, 2013

(54) USER INTERFACE ELEMENT ON MOBILE DEVICE FOR COMB TEXT FIELD INPUTS

(71) Applicant: ANAND TARALIKA, Sunnyvale, CA (US)

(72) Inventor: ANAND TARALIKA, Sunnyvale, CA (US)

(73) Assignee: ADOBE SYSTEMS INCORPORATED, SAN JOSE, CA (US)

(21) Appl. No.: 13/169,913

(22) Filed: Jun. 27, 2011

(51) Int. Cl. G06F 3/048

(52) U.S. Cl. 715/224

(57) ABSTRACT

A mobile device displays a document. Further, the mobile device receives an input in a form-field of the document. In addition, the mobile device determines a quantity of boxes that fit into the form-field. Each of the quantity of boxes has a predetermined maximum size. A plurality of mobile platform dependent text boxes is generated based on the quantity of boxes.

### BACKGROUND

1. Field

This disclosure generally relates to mobile devices. More particularly, the disclosure relates to a user interface element on a mobile device for comb text field inputs.

2. General Background

A comb text field is a text field that is divided into several combs, i.e., boxes, that are of equal dimensions laid out contiguously. Comb text fields are utilized in documents such as PDF forms, which allows a user to provide text entry into a form.

For example, a PDF form may have text fields with a property called “comb.” If the property is turned on, the text field turns into a field with contiguous text boxes. Each box may have a maximum size of one character. When the author turns the property on, the author may also determine the number of boxes that should be generated. The PDF form may then render the boxes such that the boxes are of equal dimensions.

However, utilization of comb text fields has been limited to desktop computers or laptops. For example, on a desktop computer, a form filler can fill such a comb field in a manner similar to a regular text field except that the user interface is different. As the user keys in the input, the contiguous boxes are filled one character per box. Further, the characters are center aligned and equally spaced from each other. The user can select a box and choose to edit/delete the character in that box. As a result, characters behind that box are shifted.

Technical limitations have prevented utilization of comb text fields in mobile devices. In particular, the user interfaces utilized on mobile devices simply does not support comb text fields. Accordingly, when a comb text field is rendered on a mobile device, a user typically is typically unable to interact with the comb text field.

A current approach that has been utilized to attempt to implement comb text fields on a mobile device basically turns an entire comb text field into a regular text field, i.e., individual contiguous boxes are not available. Without contiguous boxes, the user experience is not ideal and is far from what the user would expect from a comb text field. For example, the user expects that the filed will behave like a comb text field, but quickly becomes disappointed after interacting with the field to learn that the field behaves like a regular text field.

### SUMMARY

In one aspect of the disclosure, a computer program product is provided. The computer program product includes a computer useable medium having a computer readable program. The computer readable program when executed on a computer causes the computer to display, at a mobile device, a document. Further, the computer readable program when executed on the computer causes the computer to receive, at the mobile device, an input in a form-field of the document. In addition, the computer readable program when executed on the computer causes the computer to determine, at the mobile device, a quantity of boxes that fit into the form-field, each of the quantity of boxes having a predetermined maximum size. The computer readable program when executed on the computer causes the computer to generate a plurality of mobile platform dependent text boxes based on the quantity of boxes.

In another aspect of the disclosure, a process is provided. The process displays, at a mobile device, a document. Further, the process receives, at the mobile device, an input in a form-field of the document. In addition, the process determines, at the mobile device, a quantity of boxes that fit into the form-field. Each of the quantity of boxes has a predetermined maximum size. The process also generates a plurality of mobile platform dependent text boxes based on the quantity of boxes.

In yet another aspect of the disclosure, an apparatus is provided. The apparatus includes a display module that displays a document. Further, the apparatus includes a reception module that receives an input in a form-field of the document. In addition, the apparatus includes a processor that determines a quantity of boxes that fit into the form-field and generates a plurality of mobile platform dependent text boxes based on the quantity of boxes. Each of the quantity of boxes has a predetermined maximum size.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a mobile device apparatus.

FIGS. 2A-2E illustrate a display with a form in which comb fields are utilized for user input on a mobile device.

FIG. 2A illustrates the display having, as an example, a form that may be a trip booking form with fields such as date of travel, passenger name, address, city, state, country, zip code, phone number, or the like.

FIG. 2B illustrates a virtual on screen keyboard that may be utilized to input data into the form.

FIG. 2C illustrates an example of user inputs provided in a field of the form displayed in the display.

FIG. 2D illustrates an example of a delete operation being performed in the field illustrated in the display of FIG. 2C.

FIG. 2E illustrates an example of an insert operation being performed in the field illustrated in the display of FIG. 2D.

FIG. 3 illustrates a process that may be utilized for comb field generation on a mobile device.

FIG. 4 illustrates a process that may be utilized for determining comb field selection on a mobile device.

FIG. 5 illustrates a process that may be utilized for text insertion into a comb field in a display of a mobile device.

FIG. 6 illustrates a process that may be utilized for text deletion from a comb field in a display of a mobile device.

FIG. 7 illustrates a process that is utilized to perform mobile device comb-field generation.

FIG. 8 illustrates a system configuration that may be utilized for comb-field generation on a mobile device.

### DETAILED DESCRIPTION

A customized mobile text comb field is generated to provide a user with a comb field experience on mobile platforms. In one embodiment, components within an existing mobile device platform are customized to provide a plurality of comb text field inputs. Multiple mobile platform dependent regular text fields available on a mobile platform are utilized to design the comb text field inputs. In one embodiment, the mobile platform dependent regular text fields are laid out in a contiguous linear layout next to one another.

Further, in one embodiment, each of the mobile platform dependent regular text fields may have a listener module that associated therewith. Each listener module determines if a character is already in a box and if an input is intended in that particular box. For example, when a form-filler types in one of the mobile platform dependent regular text fields, the associated listener module determines if that mobile platform dependent regular text field already has a character in it or not. If the mobile platform dependent regular text field does not have a character in it, the user's input is typed into that box and the listener module associated with that mobile platform dependent regular text field automatically moves the cursor to the next box if the current box is not the last box. If the mobile platform dependent regular text field has a character in it, the characters from the current character to the last character are shifted one place to the right. The form-filler's entry is then displayed into the current box. In another embodiment, if all the boxes are already filled, the form-filler's input is disregarded.

In addition, in one embodiment, deletion of a character involves removing a character from a current box and shifting characters to the right of the current box to the left. Further, a listener module associated with current mobile platform dependent regular text field may move the cursor to the previous box.

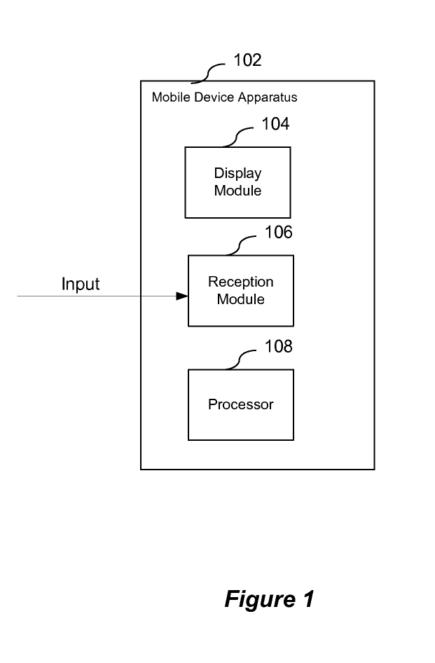

FIG. 1 illustrates a mobile device apparatus 102. The mobile device apparatus 100 may be a smartphone, tablet device, or any other portable device that has a processor. The mobile device apparatus 102 includes a display module that displays a document. Further, the mobile device apparatus 102 includes a reception module that receives an input in a form-field of the document. For example, a user may provide text input through virtual on screen keyboard on the display screen of a tablet device. In addition, the mobile device apparatus 102 includes a processor that determines a quantity of boxes that fit into the form-field and generates a plurality of mobile platform dependent text boxes based on the quantity of boxes. Each of the quantity of boxes has a predetermined maximum size. For example, the predetermined maximum size may be a character per comb field.

The mobile device apparatus 102 presents data to the user and collects data from the user through a field that acts as a comb field. As the mobile device apparatus 102 is more intuitive for interaction, the user may increase his or her interaction speed with entry of data into a document such as a form on a portable device such as a smartphone or a tablet device. Further, the user may tap on a particular box to enter a character in a particular location, which is easier for entry of data on a tablet than providing data in a regular text field.

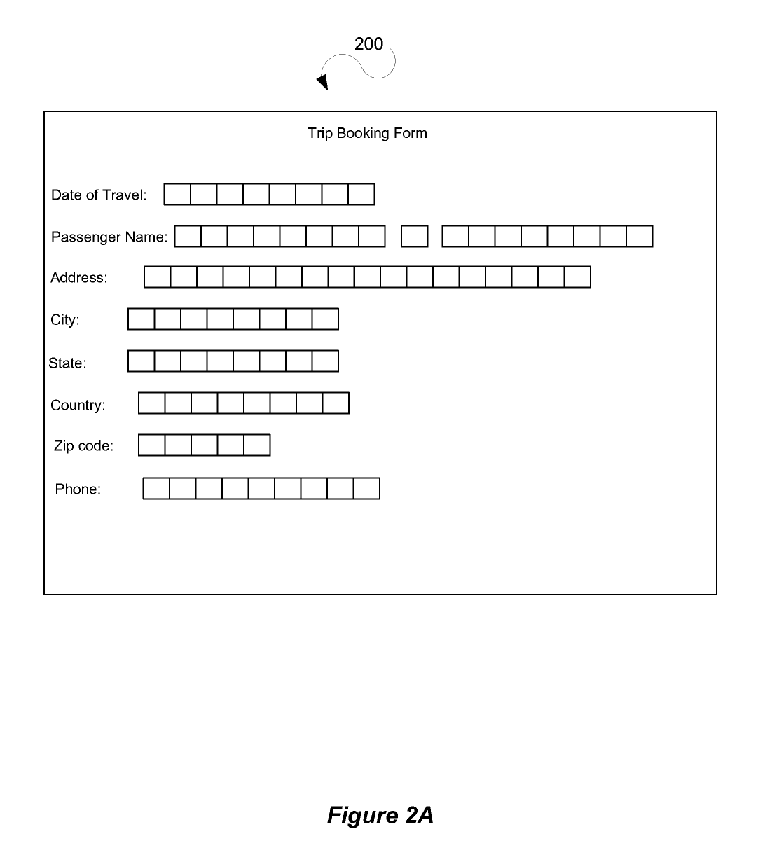

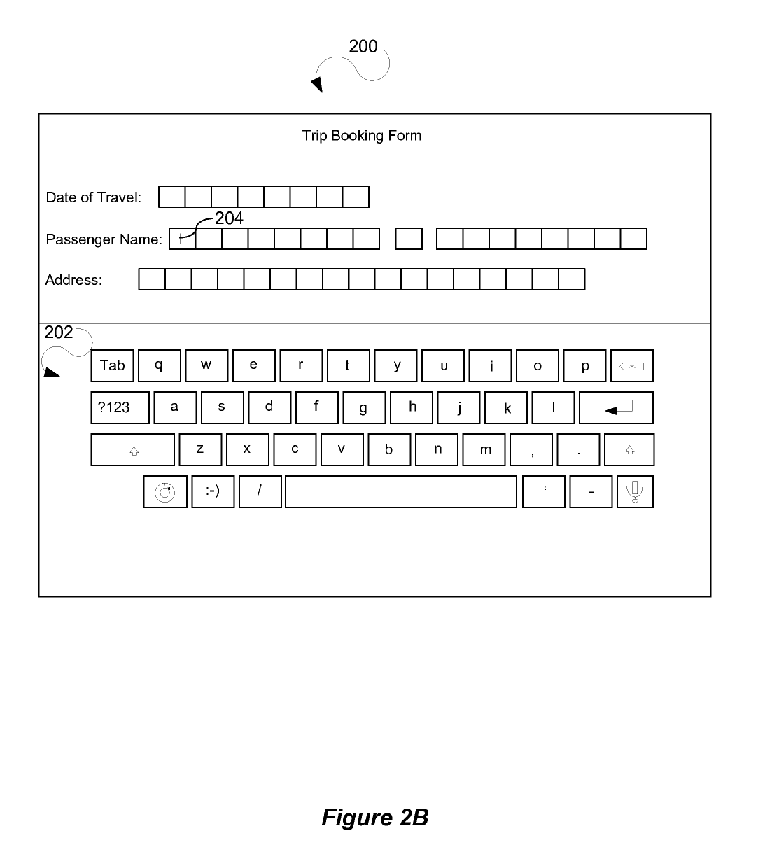

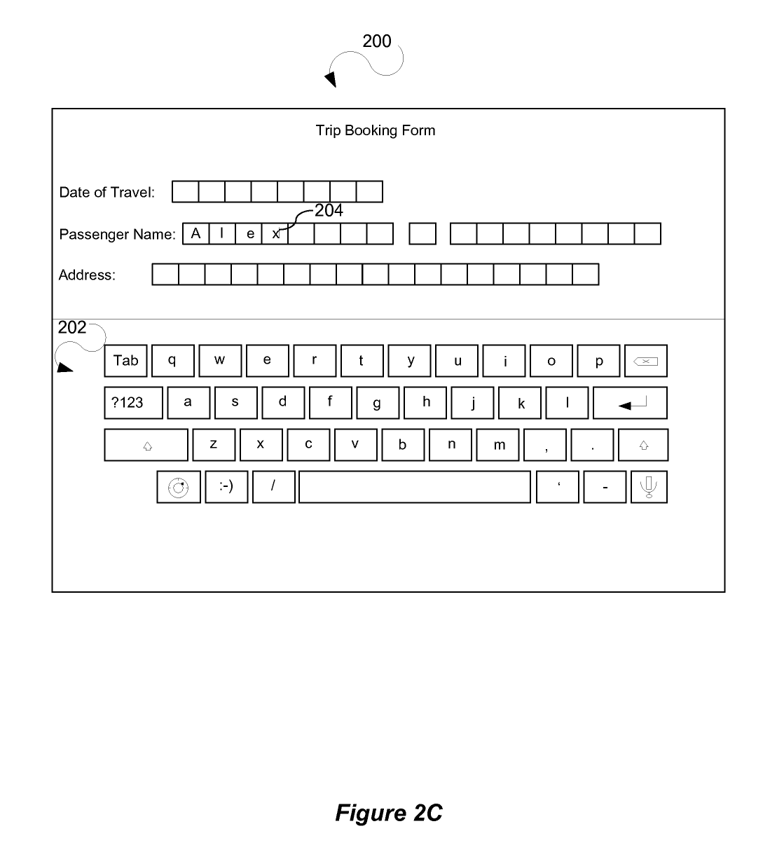

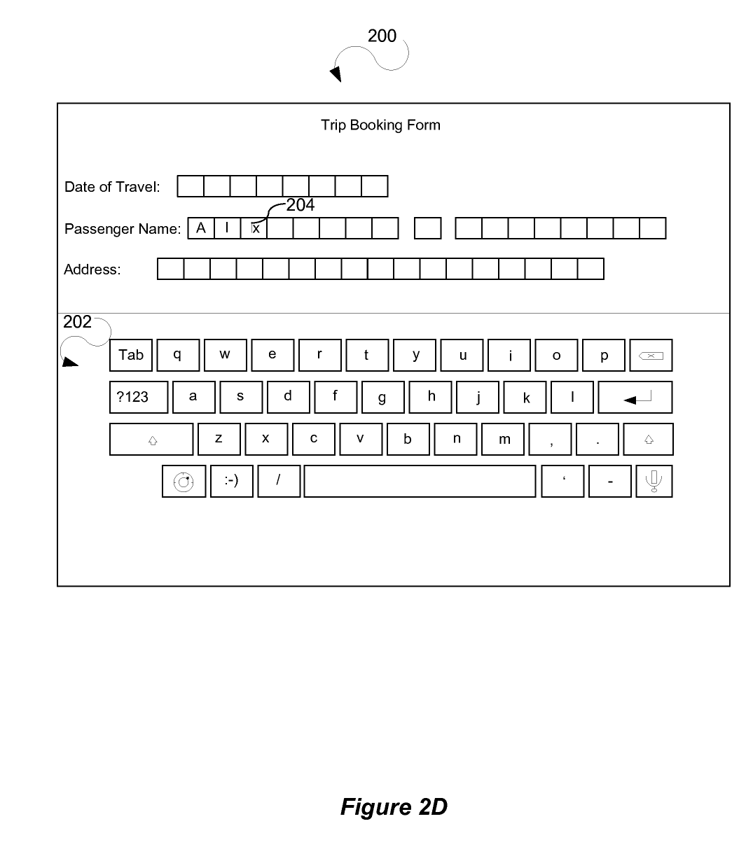

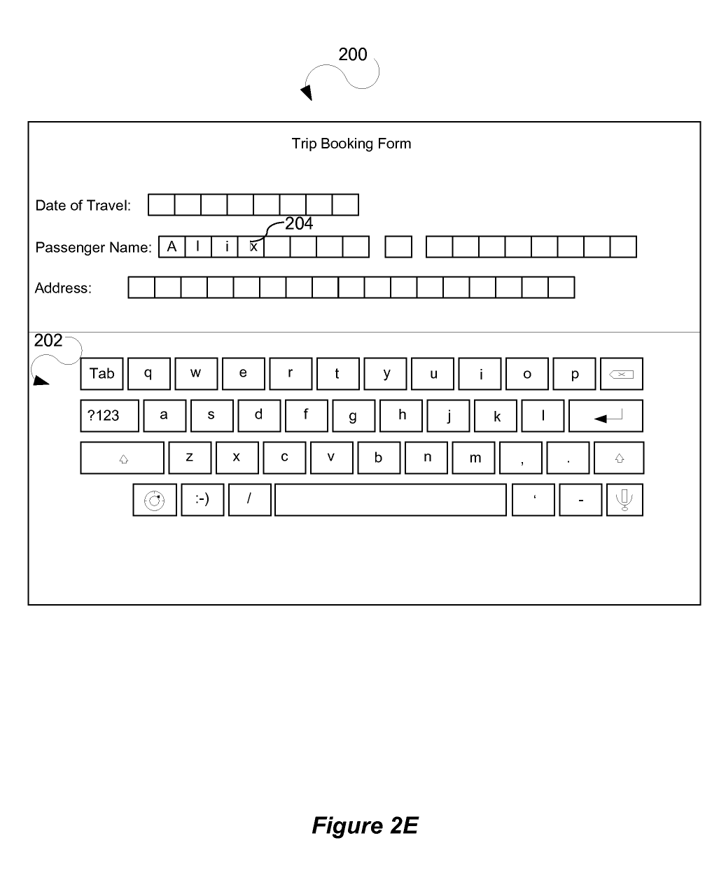

FIGS. 2A-2E illustrate a display 200 with a form in which comb fields are utilized for user input on a mobile device. FIG. 2A illustrates the display 200 having, as an example, a form that may be a trip booking form with fields such as date of travel, passenger name, address, city, state, country, zip code, phone number, or the like. Each field includes a plurality of mobile platform dependent regular text boxes that have a predetermined maximum size, e.g., a character. As an example of an input, the user may tap the field of interest such as passenger name.

FIG. 2B illustrates a virtual on screen keyboard 202 that may be utilized to input data into the form. A cursor 204 is utilized to enter input with the virtual on screen keyboard 202 into the form. For example, a user may select a particular box by tapping a box in the field of interest in a display on a tablet device. Other forms of selection, e.g., a stylus, may be utilized. As an example, the user has selected the first box in the passenger name field.

FIG. 2C illustrates an example of user inputs provided in a field of the form displayed in the display 200. As the user has inputted the letters, “A”, “I”, “e”, and “x”, the cursor 204 has moved to the box containing the letter “x”.

FIG. 2D illustrates an example of a delete operation being performed in the field illustrated in the display 200 of FIG. 2C. The user selects the box with the letter “e” and presses a delete key on the virtual on screen keyboard. After the letter “e” is deleted, the letter in the next box, “x”, is shifted left to the current box.

FIG. 2E illustrates an example of an insert operation being performed in the field illustrated in the display 200 of FIG. 2D. The user selects the box with the letter “x” and press the letter “i” on the virtual on screen keyboard. As the letter “x” is already present in that box, the letter “x” is shifted to the neighboring box to the right to make room for insertion of the letter “i” in the current box. The cursor 204 is then also moved to the box with the letter “x”.

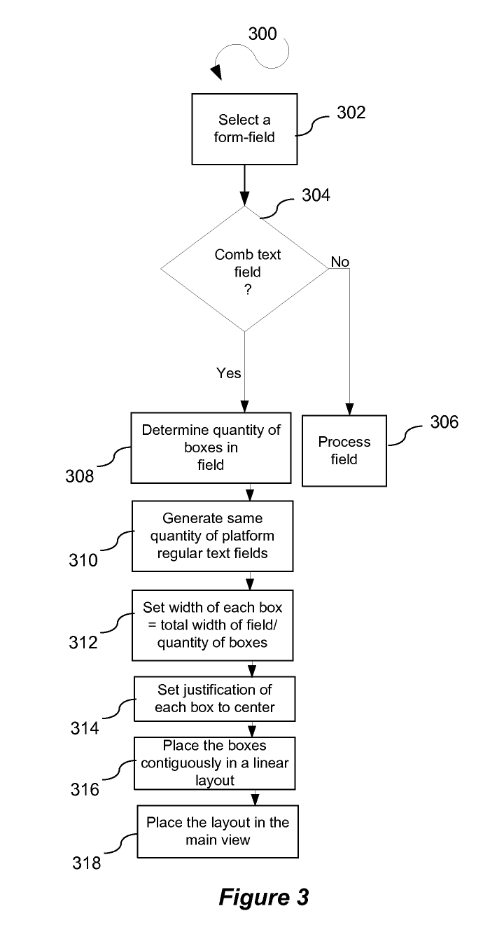

FIG. 3 illustrates a process 300 that may be utilized for comb field generation on a mobile device. At a process block 302, a form-field is selected. The selection may be via a tap selection, stylus selection, or the like. Further, a decision block 304, a determination is made as to whether or not the selected form field is a comb text field. If the selected field is not a comb text field, then the field is processed at a process block 306. If, at the decision block 304, a determination is made that the field is a comb text field, the process moves to a process block 308 to determine the quantity of boxes in the comb text field. The process 300 then moves to a process block 310 to generate the same quantity of platform dependent regular text fields as the quantity of boxes displayed in the field. In other words, rather, than providing a full regular text box for the whole field, individual mobile platform dependent boxes that are each capable of receiving inputs are generated for each of the displayed boxes. Optionally, at a process block 312, the process 300 sets of the width of each box to equal the total width of the field divided by the quantity of boxes. Other width calculations may be utilized. Further, optionally, at a process block 314, the process 300 sets the justification of each box to a center justification. Other justifications may be utilized. In addition, at a process block 316, the process 300 places the boxes contiguously in a linear layout. At a process block 318, the process 300 places the layout in the main view.

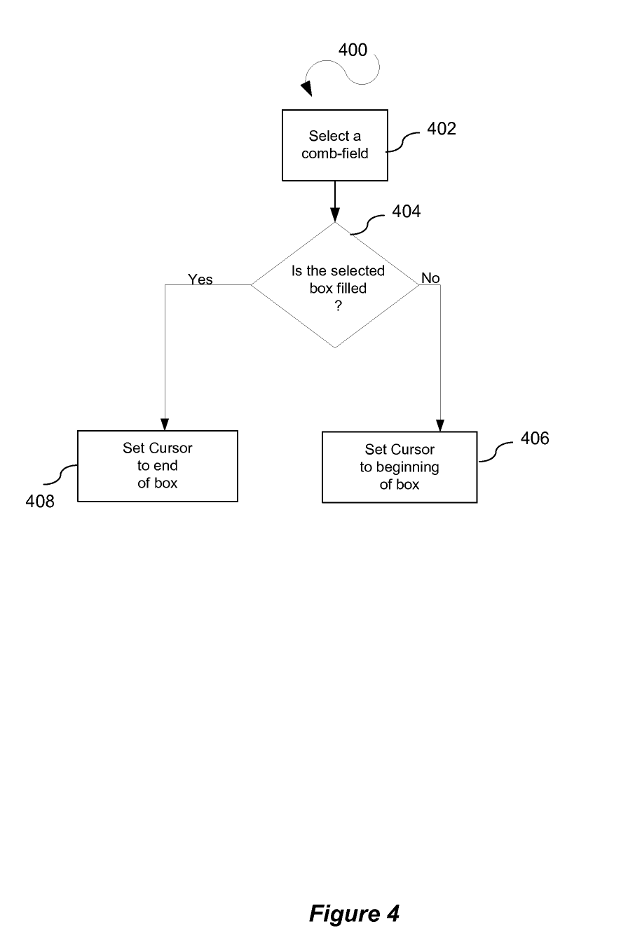

FIG. 4 illustrates a process 400 that may be utilized for determining comb field selection on a mobile device. At a process block 402, the process 400 selects a comb-field. For example, a user may select a comb-field through a tap of a tablet, stylus, or the like. The process 400 then moves to a decision block 404 to determine if the selected box is filled. If the selected box is not filled, the process 400 moves to a process block 406 to set the cursor to the beginning of the box, e.g., the left part of the box. If the selected box is determined to be filled at the decision block 404, the process 400 moves to a process block 408 to set the cursor to the end of the box.

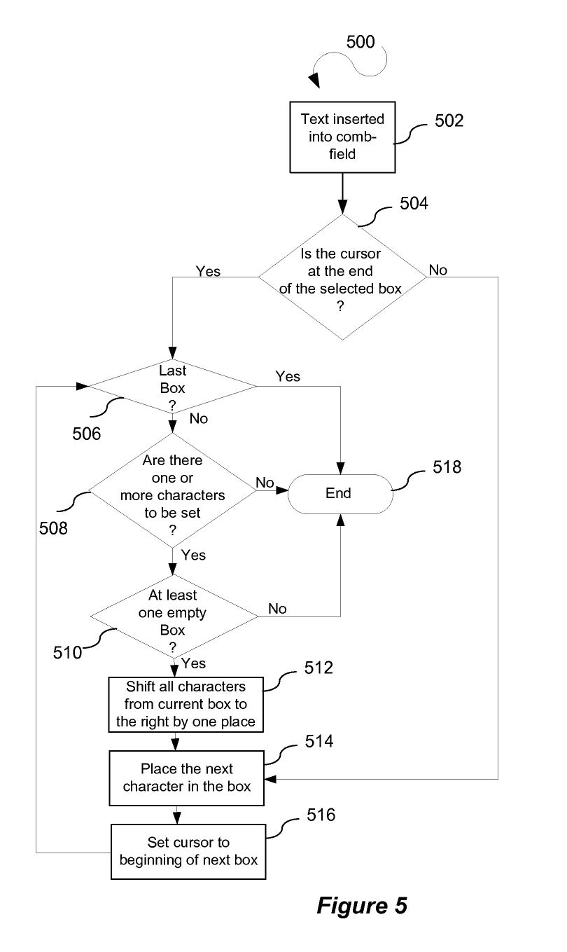

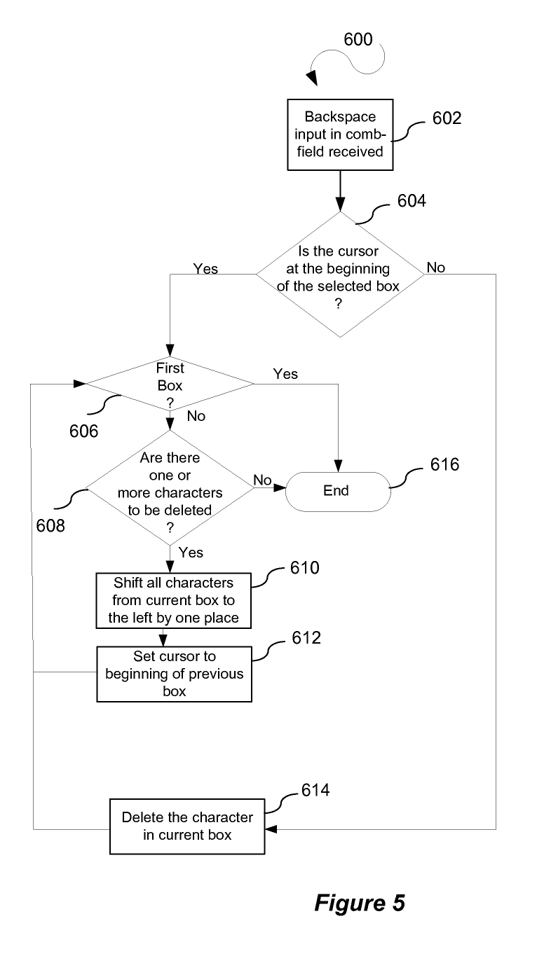

FIG. 5 illustrates a process 500 that may be utilized for text insertion into a comb field in a display of a mobile device. At a process block 502, the process 500 inserts text into a comb-field. Further, at a decision block 504, the process 500 determines if the cursor is at the end of the selected box, e.g., at the right side of the selected box. If the cursor is at the end of the selected box, the process 500 moves to a decision block 506 to determine if the selected box is the last box. If the selected box is the last box, the process 500 moves to an end block 518. If the selected box is not the last box, the process 500 moves to a decision block 508 to determine if there are one or more characters to be set. If there are not one or more characters to be set, the process 500 moves to the end block 518. If there are one or more characters to be set, the process 500 moves to a decision block 510 to determine if there is at least one empty box. If there is not at least one empty box 510, the process 500 moves to the end block 518. However, if there is at least one empty box, the process 500 moves to a process block 512 to shift all characters from the current box to the right by one place. The process 500 then moves to a process block 514 to place the next character in the box. Further, the process 500 moves to a process block 516 to set the cursor to the beginning of the next box. The process 500 then moves to the decision block 506.

At the decision block 504, if the cursor is not at the end of the selected box, the process 500 moves to the process block 514 to place the next character in the box. The process 500 then moves to a process block 516 to set the cursor to the beginning of the next box. The process 500 then moves to the decision block 506.

FIG. 6 illustrates a process 600 that may be utilized for text deletion from a comb field in a display of a mobile device. At a process block 602, the process 600 receives a backspace in the comb-field. The backspace is just an example as a variety of other delete operations may be received such as a delete command. Further, at a decision block 604, the process 600 determines if the cursor is at the beginning of the selected box, e.g., at the left side of the selected box. If the cursor is at the beginning of the selected box, the process 600 moves to a decision block 606 to determine if the selected box is the first box. If the selected box is the first box, the process 600 moves to an end block 616. If the selected box is not the first box, the process 600 moves to a decision block 608 to determine if there are one or more characters to be deleted. If there are not one or more characters to be deleted, the process 600 moves to the end block 616. If there are one or more characters to be deleted, the process 600 moves to a process block 610 to shift all characters from the current box to the left by one place. The process 600 then moves to a process block 612 to set the cursor to the beginning of the previous box. The process then moves back to the decision block 606.

At the decision block 604, if the cursor was not determined to be at the beginning of the selected box, the process 600 moves to a process bock 614 to delete the character in the current box. The process then moves to the decision bock 606.

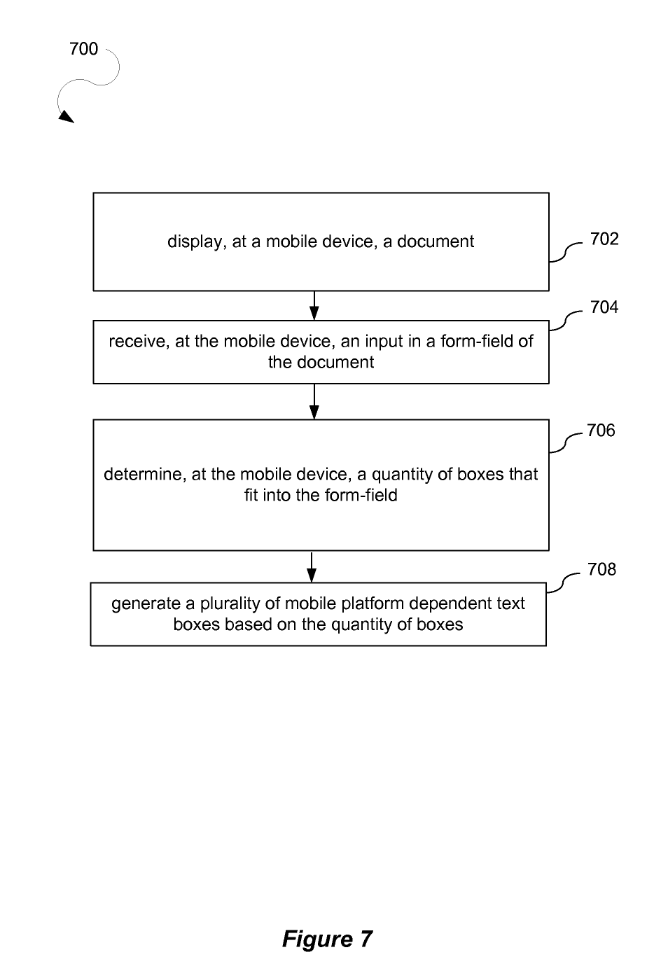

FIG. 7 illustrates a process 700 that is utilized to perform mobile device comb-field generation. At a process block 702, the process 700 displays, at a mobile device, a document. Further, at a process block 704, the process 700 receives, at the mobile device, an input in a form-field of the document. In addition, at a process block 706, the process 700 determines, at the mobile device, a quantity of boxes that fit into the form-field. Each of the quantity of boxes has a predetermined maximum size. The process 700 also generates a plurality of mobile platform dependent text boxes based on the quantity of boxes.

Any of the configurations described herein may be utilized with a variety of mobile device programs. Further, any of the configurations described herein may be utilized with a variety of different user interfaces.

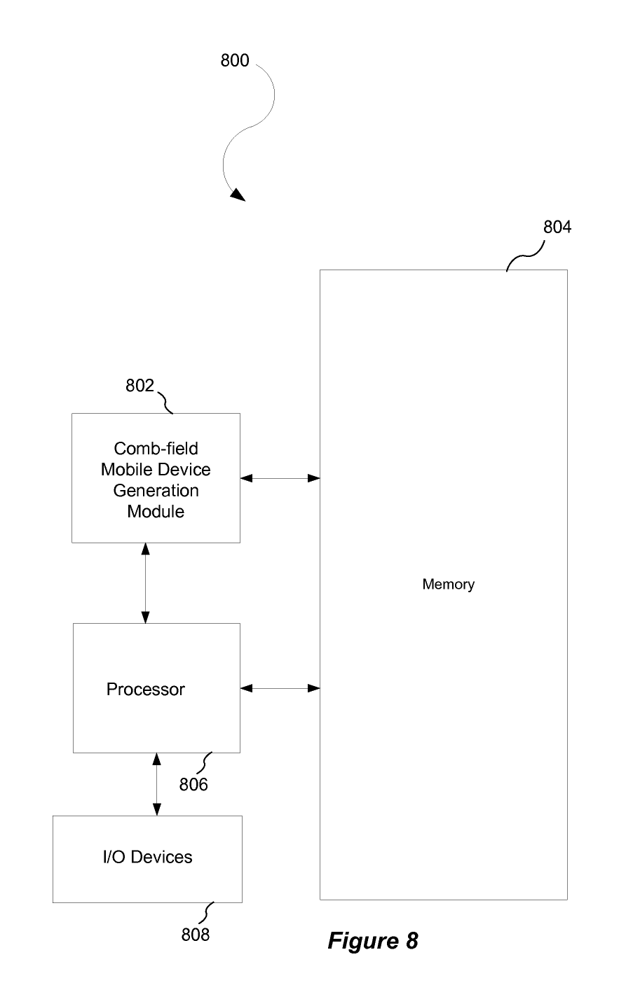

FIG. 8 illustrates a system configuration 800 that may be utilized for comb-field generation on a mobile device. In one embodiment, a comb-field mobile device generation module interacts with a memory 804 and a processor 806. In one embodiment, the system configuration 800 is suitable for storing and/or executing program code and is implemented using a general purpose computer or any other hardware equivalents. The processor 806 is coupled, either directly or indirectly, to the memory 804 through a system bus. The memory 804 can include local memory employed during actual execution of the program code, bulk storage, and/or cache memories which provide temporary storage of at least some program code in order to reduce the number of times code must be retrieved from bulk storage during execution.

The Input/Output (“I/O”) devices 808 can be coupled directly to the system configuration 800 or through intervening input/output controllers. Further, the I/O devices 808 may include a keyboard, a keypad, a mouse, a microphone for capturing speech commands, a pointing device, and other user input devices that will be recognized by one of ordinary skill in the art. Further, the I/O devices 808 may include output devices such as a printer, display screen, or the like. Further, the I/O devices 808 may include a receiver, transmitter, speaker, display, image capture sensor, biometric sensor, etc. In addition, the I/O devices 808 may include storage devices such as a tape drive, floppy drive, hard disk drive, compact disk (“CD”) drive, etc. Any of the modules described herein may be single monolithic modules or modules with functionality distributed in a cloud computing infrastructure utilizing parallel and/or pipeline processing.

Network adapters may also be coupled to the system configuration 800 to enable the system configuration 800 to become coupled to other systems, remote printers, or storage devices through intervening private or public networks. Modems, cable modems, and Ethernet cards are just a few of the currently available types of network adapters.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above.

It should be understood that the processes and systems described herein can take the form of entirely hardware embodiments, entirely software embodiments, or embodiments containing both hardware and software elements. If software is utilized to implement the method or system, the software can include but is not limited to firmware, resident software, microcode, etc.

It is understood that the processes and systems described herein may also be applied in other types of processes and systems. Those skilled in the art will appreciate that the various adaptations and modifications of the embodiments of the processes and systems described herein may be configured without departing from the scope and spirit of the present processes, systems, and computer program products. Therefore, it is to be understood that, within the scope of the appended claims, the present processes, systems, and computer program products may be practiced other than as specifically described herein.

1. A computer program product comprising one or more computer useable storage media having a computer readable program, such that the computer readable program when executed on a computer causes the computer to:
display, at a mobile device, a document;
receive, at the mobile device, an input in a form-field of the document;
determine, at the mobile device, a quantity of boxes that fit into the form-field, each of the quantity of boxes having a predetermined maximum size; and
generate a plurality of mobile platform dependent text boxes based on the quantity of boxes.

2. The computer program product of claim 1, wherein the predetermined maximum size is a character.

3. The computer program product of claim 1, wherein the computer readable program when executed on the computer further causes the computer to display the input in one of the plurality of mobile platform dependent text boxes.

4. The computer program product of claim 1, wherein the input is a character.

5. The computer program product of claim 1, wherein the computer readable program when executed on the computer further causes the computer to shift a current character in a box of the plurality of mobile platform dependent text boxes to a neighboring box of the plurality of mobile platform dependent text boxes if the input is an additional character in the box of the plurality of mobile platform dependent text boxes.

6. The computer program product of claim 1, wherein the computer readable program when executed on the computer further causes the computer to shift a neighboring character in a box of the plurality of mobile platform dependent text boxes to a current box of the plurality of mobile platform dependent text boxes if the input is a delete operation of a current character in the current box.

7. The computer program product of claim 1, wherein the plurality of mobile platform dependent text boxes is arranged contiguously in a linear layout.

8. A method comprising:
displaying, at a mobile device, a document;
receiving, at the mobile device, an input in a form-field of the document;
determining, at the mobile device, a quantity of boxes that fit into the form-field, each of the quantity of boxes having a predetermined maximum size; and
generating a plurality of mobile platform dependent text boxes based on the quantity of boxes.

9. The method of claim 8, wherein the predetermined maximum size is a character.

10. The method of claim 8, further comprising displaying the input in one of the plurality of mobile platform dependent text boxes.

11. The method of claim 8, wherein the input is a character.

12. The method of claim 8, further comprising shifting a current character in a box of the plurality of mobile platform dependent text boxes to a neighboring box of the plurality of mobile platform dependent text boxes if the input is an additional character in the box of the plurality of mobile platform dependent text boxes.

13. The method of claim 8, further comprising shifting a neighboring character in a box of the plurality of mobile platform dependent text boxes to a current box of the plurality of mobile platform dependent text boxes if the input is a delete operation of a current character in the current box.

14. The method of claim 8, wherein the plurality of mobile platform dependent text boxes is arranged contiguously in a linear layout.

15. An apparatus comprising:
a display module that displays a document;
a reception module that receives an input in a form-field of the document; and
a processor that determines a quantity of boxes that fit into the form-field and generates a plurality of mobile platform dependent text boxes based on the quantity of boxes, each of the quantity of boxes having a predetermined maximum size.

16. The apparatus of claim 15, wherein the predetermined maximum size is a character.

17. The apparatus of claim 15, further comprising displaying the input in one of the plurality of mobile platform dependent text boxes.

18. The apparatus of claim 15, wherein the input is a character.

19. The apparatus of claim 15, wherein the processor shifts a current character in a box of the plurality of mobile platform dependent text boxes to a neighboring box of the plurality of mobile platform dependent text boxes if the input is an additional character in the box of the plurality of mobile platform dependent text boxes.

20. The apparatus of claim 15, wherein the processor shifts a neighboring character in a box of the plurality of mobile platform dependent text boxes to a current box of the plurality of mobile platform dependent text boxes if the input is a delete operation of a current character in the current box.
